(19) United States
(12) Patent Application Publication
(10) Pub. No.: US 2005/0114479 A1
(43) Pub. Date: May 26, 2005

(54) System and method for hierarchically representing configuration items

(76) Inventor: Brett Watson-Luke, Indooroopilly (AU)

Correspondence Address: Schwegman, Lundberg, Woessner & Kluth, P.A., P.O. Box 2938, Minneapolis, MN, 55402, US

(21) Appl. No.: 10/723,581

(22) Filed: Nov. 26, 2003

(51) Int. Cl. G06F 15/177; G06F 3/00

(52) U.S. Cl. 709/220; 715/735

(57) ABSTRACT

A system and method for hierarchically representing configuration items are described herein. In one embodiment, the method includes receiving a request to modify one or more configuration items, wherein the request is associated with a direct manipulation GUI command, wherein the configuration items are associated with configuration item icons, and wherein the configuration items are stored in a configuration management system repository. The method further includes modifying the one or more configuration items, wherein the modifying includes modifying high-level representations of the one or more configuration items. The method further includes generating low-level representations of the one or more configuration items, and exporting the low-level representations to a database.

### RELATED FILES

This invention is related to the following cofiled, coassigned and copending applications:

application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.825US1);

application Ser. No. ______, filed Nov. 26, 2003, entitled “SYSTEM AND METHOD FOR MANAGING OSS COMPONENT CONFIGURATION” (Attorney Docket No.: 500.827US1);

application Ser. No. ______, filed Nov. 26, 2003, entitled “SYSTEM AND METHOD FOR CONFIGURING A GRAPHICAL USER INTERFACE BASED ON DATA TYPE” (Attorney Docket No.: 500.829US1);

application Ser. No. ______, filed Nov. 26, 2003, entitled “BIDIRECTIONAL INTERFACE FOR CONFIGURING OSS COMPONENTS”(Attorney Docket No.: 500.830US1); and

Provisional application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.83 1PRV); all of the above which are hereby incorporated by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. patent and Trademark Office file or records, but reserves all other rights whatsoever.

### FIELD

This invention relates generally to the field of operational support system software and more particularly to graphical user interfaces used in conjunction with operational support system software.

### BACKGROUND

Telecommunications providers offer a wide variety of products and services to their continuously expanding consumer bases. In order to keep pace with ever-changing products and customer demands, many telecommunications providers employ Operations Support Systems (OSS) to track resource provisioning, convergent billing, customer management information, and other telecommunication-related information. The OSS typically includes a number of separate databases for storing the information related to resource provisioning, convergent billing, etc. One disadvantage of some OSS is that several different databases have to be updated when new products and services are offered. For example, when a new wireless Internet plan is offered, both the convergent billing and customer management information databases must be updated. Another disadvantage of many OSS is that some OSS do not offer relatively fast and easy-to-use tools for changing information across numerous OSS databases.

### BRIEF DESCRIPTION OF THE FIGURES

The present invention is illustrated by way of example and not limitation in the Figures of the accompanying drawings in which:

FIG. 1 illustrates an exemplary computer system used in conjunction with certain embodiments of the invention;

FIG. 2 is a block diagram illustrating a configuration management system, according to exemplary embodiments of the invention;

FIG. 3 is a block diagram illustrating a more detailed view of the configuration server and other configuration management system components, according to exemplary embodiments of the invention;

FIG. 4 is a screenshot of the graphical user interface presented by the graphical tools user interface unit, according to exemplary embodiments of the invention

FIG. 5 is a flow diagram illustrating operations for processing graphical user interface commands in a configuration management system, according to exemplary embodiments of the invention;

FIG. 6 is a flow diagram illustrating a operations for modifying configuration in response to commands received through a graphical user interface, according to exemplary the embodiments of the invention; and

FIG. 7 is a flow diagram illustrating operations for generating a low-level configuration items from high-level configuration items, according to exemplary embodiments of the invention.

### DESCRIPTION OF THE EMBODIMENTS

Systems and methods for hierarchically representing configuration items are described herein. In the following description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams will be described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Moreover, it should be understood that although the flow diagrams depict serial operations, certain embodiments could perform certain of those operations in parallel.

This description of the embodiments is divided into three sections. In the first section, an exemplary computer system and operating environment is described. In the second section, a system level overview is presented. In the third section, an exemplary implementation is described.

### Hardware and Operating Environment

This section provides an overview of the exemplary hardware and the operating environment in which embodiments of the invention can be practiced.

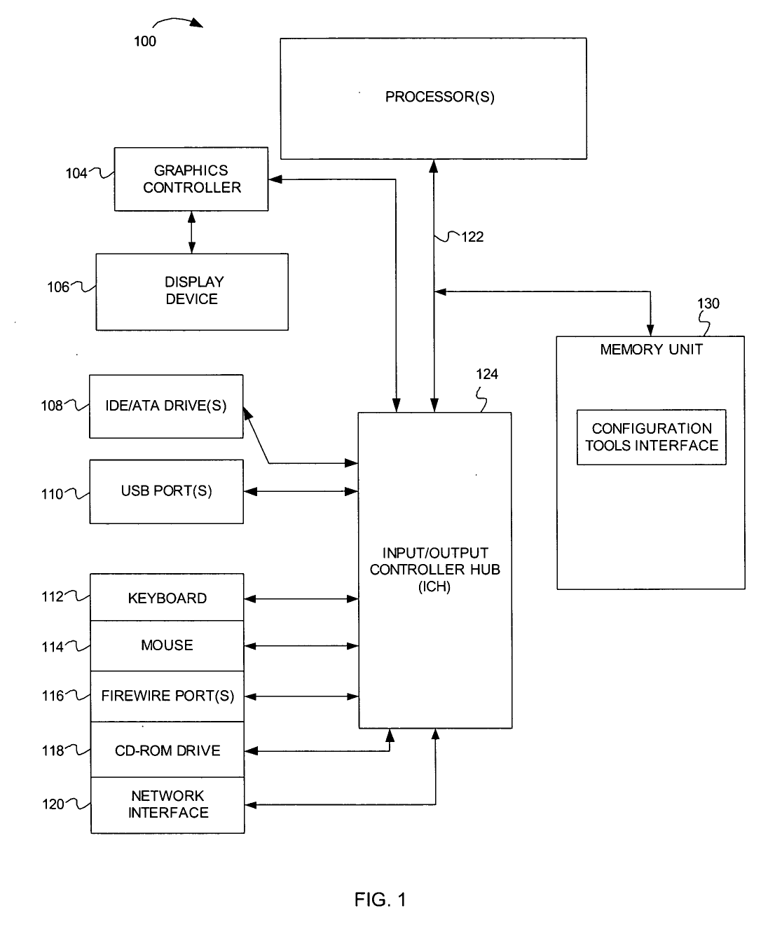

FIG. 1 illustrates an exemplary computer system used in conjunction with certain embodiments of the invention. As illustrated in FIG. 1, computer system 100 comprises processor(s) 102. The computer system 100 also includes a memory unit 130, processor bus 122, and Input/Output controller hub (ICH) 124. The processor(s) 102, memory unit 130, and ICH 124 are coupled to the processor bus 122. The processor(s) 102 may comprise any suitable processor architecture. The computer system 100 may comprise one, two, three, or more processors, any of which may execute a set of instructions in accordance with embodiments of the present invention.

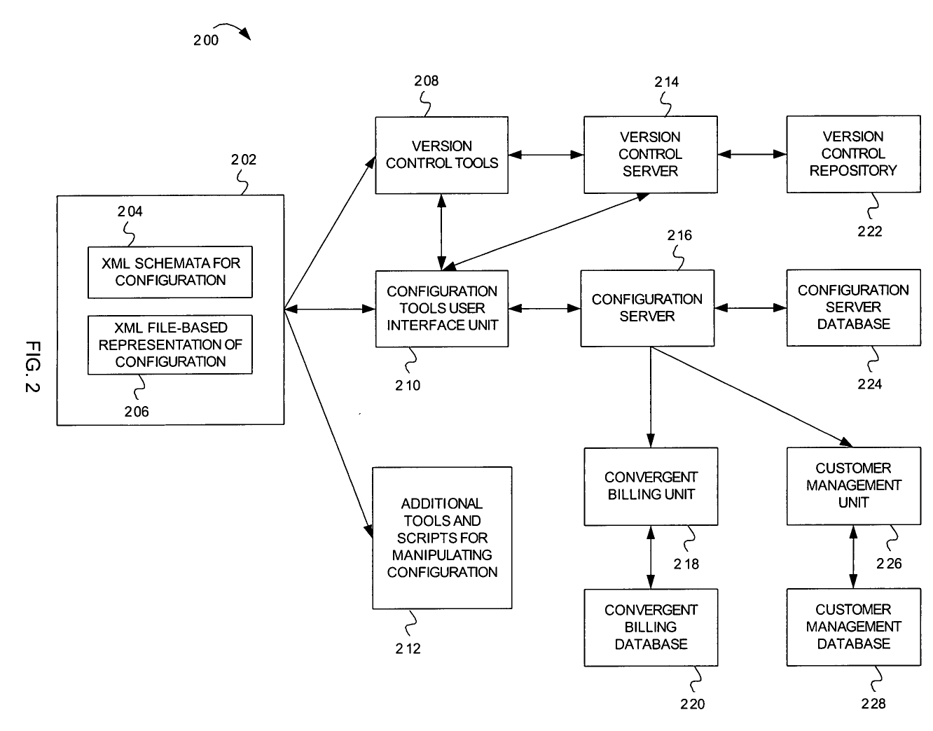

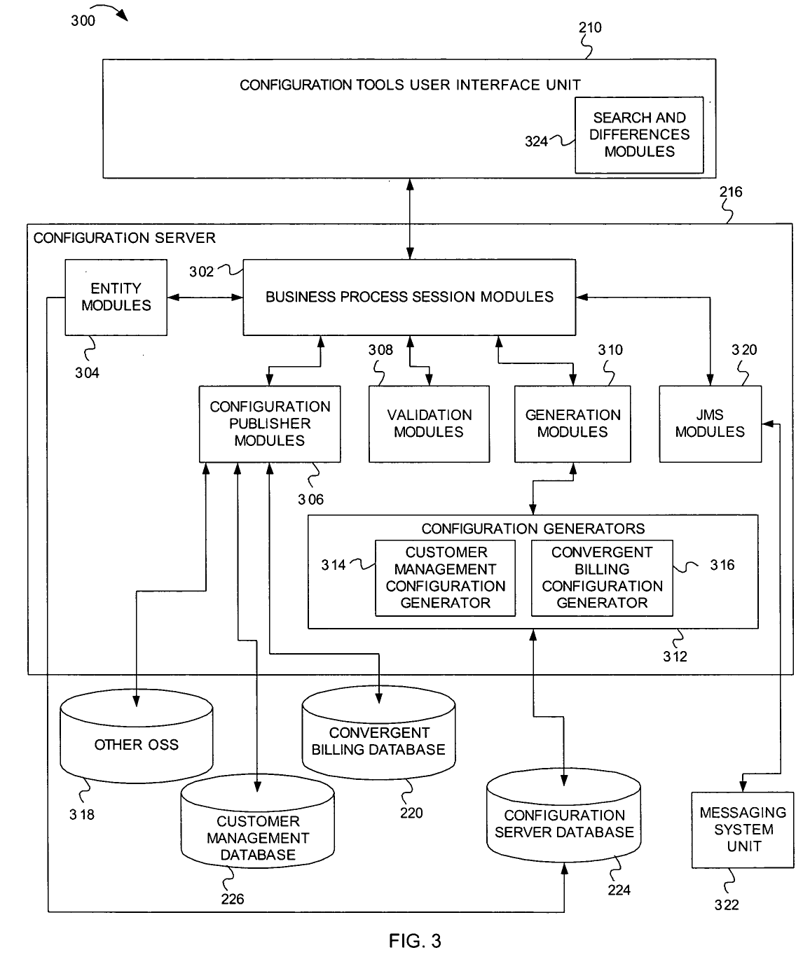

The memory unit 130 includes a configuration tools interface, which is described in greater detail below (see FIGS. 2 and 3). The memory unit 130 stores data and/or instructions, and may comprise any suitable memory, such as a dynamic random access memory (DRAM), for example. The computer system 100 also includes IDE drive(s) 108 and/or other suitable storage devices. A graphics controller 104 controls the display of information on a display device 106, according to embodiments of the invention.

The input/output controller hub (ICH) 124 provides an interface to I/O devices or peripheral components for the computer system 100. The ICH 124 may comprise any suitable interface controller to provide for any suitable communication link to the processor(s) 102, memory unit 130 and/or to any suitable device or component in communication with the ICH 124. For one embodiment of the invention, the ICH 124 provides suitable arbitration and buffering for each interface.

For one embodiment of the invention, the ICH 124 provides an interface to one or more suitable integrated drive electronics (IDE) drives 108, such as a hard disk drive (HDD) or compact disc read only memory (CD ROM) drive, or to suitable universal serial bus (USB) devices through one or more USB ports 110. For one embodiment, the ICH 124 also provides an interface to a keyboard 112, a mouse 114, a CD-ROM drive 118, one or more suitable devices through one or more firewire ports 116. For one embodiment of the invention, the ICH 124 also provides a network interface 120 though which the computer system 100 can communicate with other computers and/or devices. In one embodiment, the computer system 100 includes a machine-readable medium that stores a set of instructions (e.g., software) embodying any one, or all, of the methodologies for dynamically loading object modules described herein. Furthermore, software can reside, completely or at least partially, within memory unit 130 and/or within the processor(s) 102.

### System Level Overview

This section provides a system level overview of exemplary embodiments of the invention. FIG. 2 shows a block diagram of a system for managing configuration. Operations of the components of FIG. 2 are described in the following sections.

FIG. 2 is a block diagram illustrating a configuration management system used in conjunction with an operations support system, according to exemplary embodiments of the invention. In one embodiment, an operations support system (OSS) generally refers to a system for performing management, inventory, engineering, planning, and repair functions for communications service providers and their networks.

As shown in FIG. 2, the configuration management system 200 includes an Extensible Markup Language repository (shown as XML repository 202), which includes XML schemata 204 for representing configuration and an XML file-based representation of configuration 206. In one embodiment, configuration is a set of one or more configuration items. In one embodiment, configuration items are data that change the operations or behavior of the one or more components of the configuration management system 200 (e.g., the convergent billing database 220, customer management database 226, OSS 318). In an alternative embodiment, the configuration items are represented in any suitable fashion (e.g., the configuration items can be represented in any suitable markup language). The XML repository 202 is connected to version control tools 208, configuration tools user interface 210, and additional tools and scripts for manipulating configuration 212. The configuration tools user interface 210 is connected to the version control tools 208, a version control server 214, and a configuration server 216. The version control tools 208 is connected with the version control server 214, which is connected to a version control repository 212. The configuration server 216 is connected to a configuration server database 224, a convergent billing unit 218, and a customer management unit 226. The convergent billing unit 218 is connected to a convergent billing database 220, while the customer management unit 226 is connected to a customer management database 228. In one embodiment, the configuration server database 224, convergent billing unit 218, and customer management unit 226 are OSSs. According to embodiments of the invention, the configuration server 216 can be connected to additional components, such as a provisioning management unit and a provisioning management database. In one embodiment, the additional components can be added after the configuration management system 200 has been deployed in the field.

In the configuration management system 200, the version control tools 208, version control server 214, and version control repository 212 are used for tracking version information associated with configuration stored in the system's various storage units (e.g., the XML repository 202, convergent billing database 220, customer management database 228, etc.). These components include basic tools for committing changes to configuration, viewing differences between configuration versions, and grouping configuration items based on version.

In the configuration management system 200, low-level representations of configuration are stored in the convergent billing database 220, the customer management database 228, and configuration server 216. In one embodiment, low-level configuration representations include relational database representations (i.e., configuration are represented as a number of related tables and data fields) of the configuration. In one embodiment, the low-level configuration is represented in XML. However, other embodiments call for other suitable low-level persistent representations of the configuration. The low-level configuration stored in the configuration server 216 provides an XML representation of OSS-specific configuration. Having an XML representation allows third parties to maintain the configuration items of the configuration management system 200.

In one embodiment, the configuration server 224 and the XML repository 202 store high-level representations (also referred to as file-based representations) of the configuration. The high-level representations of the configuration can be used for updating configuration stored in the various databases (e.g., the convergent billing database 220 and the customer management database 228), as described in greater detail below (see exemplary implementation section). In one embodiment of the invention, the high-level representations of the configuration include XML representations of configuration. The high-level XML configuration allows third parties to restructure the low-level XML configuration, so its format is not specific any OSS. Additionally, the high-level configuration is relatively more user-friendly because it abstracts many details present in the low-level configuration. In alternative embodiments, the high-level representations include other suitable representations of the configuration (e.g., other markup language representations of the configuration).

The XML schemata 204 define the structure and content of the high-level configuration representation. Various components of the configuration management system 200 (e.g., the configuration tools user interface 210) use information contained within the XML schemata 204 when reading and processing configuration. For example, the configuration tools user interface unit 210 uses the XML schemata 204 and the XML file-based representation of configuration 206 for processing configuration. Additionally, the configuration tools user interface unit 210 presents various user interface components based on the XML schemata 204 and the high-level representations of configuration, as described in greater detail throughout this description.

In one embodiment of the invention, the convergent billing unit 218 and the convergent billing database 220 store and process configuration used in executing a convergent billing system. The customer management unit 226 and the customer management database 228 store and process configuration used in executing a customer management system. These OSSs can also perform billing and customer functions.

FIG. 3 is a block diagram illustrating a more detailed view of the configuration server and other configuration management system components, according to exemplary embodiments of the invention. As shown in FIG. 3, the configuration management system 200 includes a configuration tools user interface unit 210, which is connected to a configuration server 216. As shown in FIG. 3, the configuration tools user interface unit 210 includes a search and differences modules 324 As shown in FIG. 3, the configuration server includes business process session modules 302, which provide an interface to the configuration tools user interface unit 210. The business process session modules 302 are connected to entity modules 304, configuration publisher modules 306, validation modules 308, generation modules 310, and JMS modules 320. The JMS modules 320 are connected to a messaging system unit 322. As shown in FIG. 3, the configuration publisher modules are connected to the customer management database 226, convergent billing database 220, and other OSS components 318. As shown in FIG. 3, the generation modules are connected to configuration generators 312, which include a customer management configuration generator 314 and a convergent billing configuration generators 316. The configuration generators 304 are connected to the configuration server database 224.

In one embodiment, the business process session modules 302 provide a business process interface to the configuration tools 210. When the configuration tools user interface unit 302 performs operations that invoke functionality of the configuration server 216, the business process session modules 302 coordinates completion of the operations. The entity modules 304 represent persistent information stored in a database. In one embodiment, the entity modules 304 include configuration items, status records, audit records, system settings, charge records, configuration item references, and other information about the configuration management system 200.

In one embodiment, the configuration publisher modules 306 import configuration into the configuration server 216 from the convergent billing database 220 and the other OSS components 318. The configuration publisher modules 306 also export configuration from the configuration server 216 to the convergent billing database 220, customer management database 226, and other OSS components 318. The configuration publisher modules 306 also provide support for validating configuration updates. These validations are different from validation is provided by the validation modules 308, as the configuration publisher modules 306 can examine existing configuration in the OSS determine whether changes are acceptable. In one embodiment, discrepancies may occur between the configuration stored in the configuration server 216 and configuration stored in the customer management database 226, convergent billing database 220, and configuration server database 224. Such discrepancies may be caused by system failure or premature system shutdowns. The configuration publisher modules 306 record details about the configuration stored in the configuration server, enabling it to determine and correct to discrepancies.

In one embodiment, the JMS modules 320 inform systems connected to the configuration server 216 (e.g., configuration tools user interface unit 210) when configuration items are modified. In one embodiment, the JMS module 320 employs a publisher subscribe model to notify systems about configuration changes. In one embodiment, the JMS module reads and writes messages to/from a topic, which provides the ability to filter notifications. As a result, one notification is available to multiple systems and the systems receive only those notifications that are pertinent to themselves. In one embodiment, the JMS module can send messages sent to a topic to other messaging systems via a bridge, shown as a connection between the JMS module 320 and messaging system unit 322. In one embodiment, the JMS module 320 supports message persistence, which means that messages are persistently stored until the message consumer has processed the message.

According to embodiments of the invention, the components (e.g., the entity modules 304, configuration publisher modules 306, etc.) of the configuration server 216 can be integrated or divided, forming a lesser or greater number of components. According to embodiments, the components can include queues, stacks, and/or other data structures necessary for performing the functionality described herein. Moreover, the components units can be logically/communicatively coupled using any suitable communication method (message passing, parameter passing, signals, etc.). Additionally, the components can be connected according to any suitable interconnection architecture (fully connected, hypercube, etc.). Any of the components used in conjunction with embodiments of the invention can include machine-readable media for performing operations described herein. Machine-readable media includes any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals, etc.), etc. According to embodiments of the invention, the components can be other types of logic (e.g., digital logic) for executing the operations for hierarchically representing configuration described herein.

### Exemplary Implementation

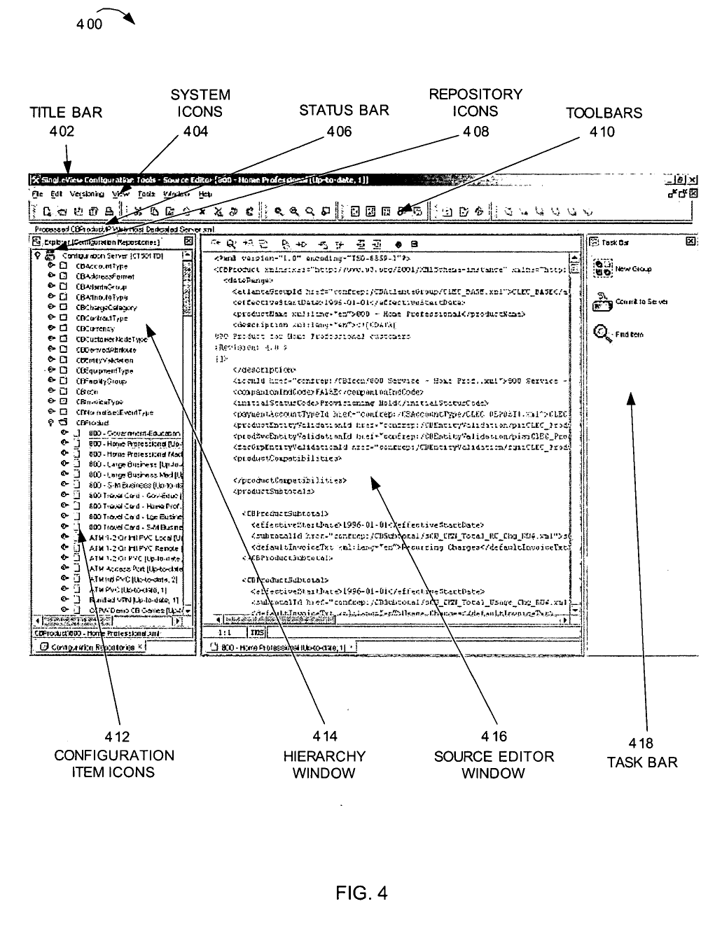

FIG. 4 is a screenshot of the graphical user interface presented by the graphical tools user interface unit, according to exemplary embodiments of the invention. As shown in FIG. 4, the screenshot includes a set of GUI components 400. The GUI components 400 include a title bar 402, which is located at the top edge of the GUI components 400. The title bar 402 displays an application program name and other application program information. The title bar 402 also includes minimize, maximize, and exit buttons, which are displayed in the upper right comer of the GUI components 400. Additionally, the GUI components 400 include system icons 404, toolbars 410, status bar 406, and repository icons 408. A source editor window 416 is shown adjacent to the hierarchy window 412, while a taskbar 416 a shown adjacent to the source editor window 414.

The GUI components 400 also include a hierarchy window 414, which displays a hierarchical view of various configuration items stored within the configuration management system 200. The hierarchy window 414 includes configuration item icons 412. In one embodiment, the highest level of the hierarchy is a configuration server, while configuration items are show at intermediate levels of the hierarchy. In one embodiment, configuration items are shown as folders in the hierarchy. Configuration item attributes are at a hierarchy level below the configuration items. In one embodiment, configuration attributes include references to other configuration items.

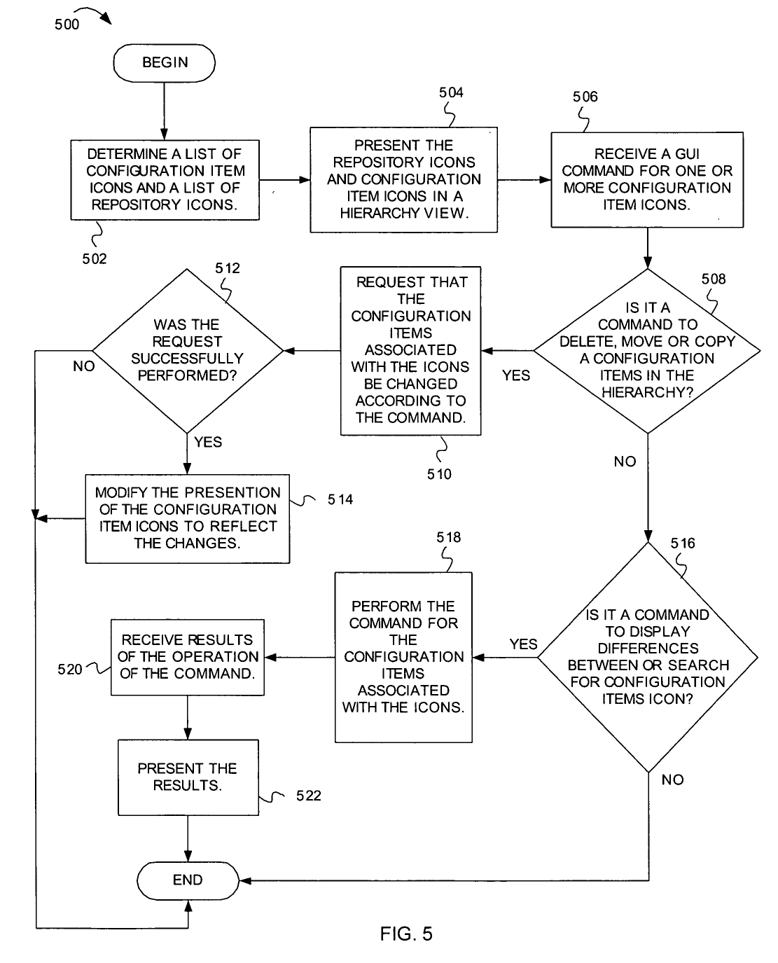

While FIG. 4 describes a screenshot and hierarchy view of configuration items presented by the configuration tools interface unit 210, FIGS. 5-7 describe operations for processing GUI commands vis-à-vis stored configuration. In particular, FIGS. 5-7 describe operations for presenting configuration items in a well-organized easy-to-understand hierarchy. Additionally, FIGS. 5-7 describe operations for receiving and processing GUI commands (e.g., move, copy, paste, delete, search, etc.) associated with configuration items shown in the hierarchy. The operations make changes to the actual configuration items (stored in databases) based on the GUI commands.

FIG. 5 is a flow diagram illustrating operations for processing graphical user interface commands in a configuration management system, according to exemplary embodiments of the invention. The flow diagram 500 will be described with reference to the exemplary configuration management system shown in FIGS. 2 and 3. The flow diagram 500 commences at block 502.

At block 502, lists of configuration item icons and repository icons are determined. For example, the configuration tools user interface unit 210 determines a list of configuration item icons and a list of repository icons. In one embodiment, the configuration tools user interface unit 210 determines the lists of configuration item icons and repository icons based on the configuration stored in the configuration server database 224. In one embodiment, the configuration is based on low-level configuration imported from the convergent billing database 220 and the customer management database 226. For example, the configuration tools user interface unit 210 adds a configuration item icon to the list for each configuration item stored in the configuration server. In one embodiment, the configuration tools user interface unit 210 determines the list of configuration item icons based on configuration stored in the convergent billing database 220 and/or the customer management database 228. In one embodiment, the configuration icons are named. In one embodiment, a user can change the configuration icon names. The flow continues at block 504.

As shown in block 504, the repository icons and configuration item icons are presented in a hierarchy view. For example, the configuration tools user interface unit 210 presents the repository icons and configuration item icons in a hierarchy view. In one embodiment, as shown in FIG. 4, the configuration tools user interface unit 210 presents the repository icons 408 and the configuration item icons 412 in a hierarchy window 414. As noted above, in one embodiment, repository icons are presented at the highest hierarchy level, while configuration items are presented at the intermediate hierarchy level. Configuration item attributes are presented at a hierarchy level below the configuration items. In one embodiment, the hierarchy view is presented by itself in a window. In an alternative embodiment, the hierarchy is presented in a window along with other icons. In one embodiment, a user can customize the hierarchy structure. The flow continues at block 506.

At block 506, a graphical user interface (GUI) command associated with one or more configuration icons is received. For example, the configuration tools user interface unit 210 receives a GUI command associated with one or more configuration icons. In one embodiment, the GUI command is associated with a mouse click and an icon, while in alternative embodiments, the GUI command is associated with input from other input sources (e.g., touchscreen, trackball, voice-recognition software, etc.). In one embodiment, the GUI command is a mouse click associated with one or more configuration item icons or menu items. For example, the GUI command represents a user mouse clicking on one or more configuration item icons or menu items.

In one embodiment, the menu items include a delete item, copy item, search item, and difference item. In one embodiment, the delete item is associated with a delete command, which deletes a configuration item associated with a selected configuration item icon. In one embodiment, the copy item is associated with a copy command, which copies a configuration item associated with a selected configuration item icon. In one embodiment, the search item is associated with a search command, which searches the various databases for configuration items (e.g., a folder of configuration items). In one embodiment, the difference item is associated with a difference command, which presents differences between configuration items associated with selected configuration item icons. In one embodiment, the GUI command is a move command, which moves configuration item icons about the hierarchy, while also moving configuration items to different repositories in the configuration management system 200. In one embodiment, when the configuration management system 200 executes the commands associated with the menu items, it performs operations on configuration items stored throughout the configuration management system 200 and graphically presents the results, as described below (see discussion of block 514).

In one embodiment, the GUI command is a mouse click associated with one or more configuration item icons or menu items. For example, a GUI command occurs when a user moves the mouse pointer over an icon representing a configuration item and presses a mouse button. In one embodiment GUI commands can be implemented as a drag-and-drop commands. Dragging occurs when a user holds down a mouse button while moving the mouse pointer to another place on the screen (e.g., another location in the hierarchy), where a selected configuration item icon moves along with the mouse pointer. Dropping occurs when the user releases the mouse button, thus placing the selected configuration item icon at the other screen location. In one embodiment, configuration items can be created, deleted, and modified using drag-and-drop GUI commands implemented in a drag-and-drop fashion. The flow continues at block 508.

As shown in block 508, it is determined whether the GUI command is a command to delete, move, or copy configuration items of the hierarchy. For example, the configuration tools user interface unit 210 determines whether the GUI command is a command to delete, move, or copy configuration items associated with the configuration item icons presented in the hierarchy. If the command is a command to delete, move, or copy a configuration item in the hierarchy, the flow continues at block 510. Otherwise, the flow continues at block 516.

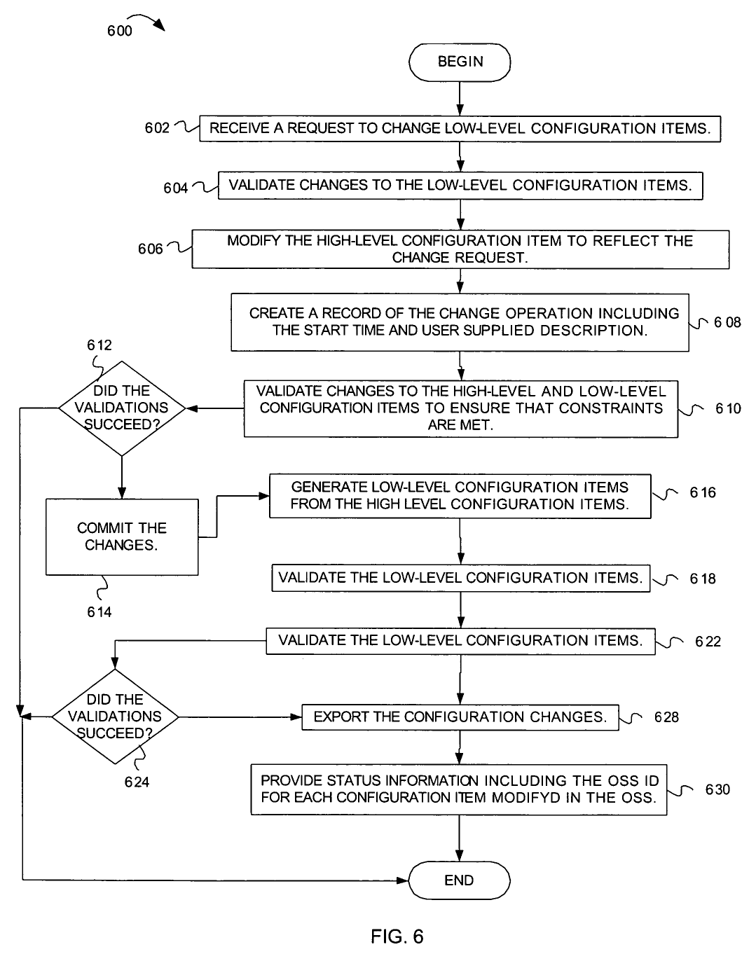

At block 510, a request is made to change the configuration items according to the command. For example, the configuration tools user interface unit 210 requests that the configuration server 216 change the configuration items according to the command. For example, in one embodiment, the configuration tools user interface unit 210 requests that the configuration server 216 perform operations for creating configuration items in the various databases (e.g., customer management database 26, convergent billing database 220, etc.) according to a GUI command. As a more specific example, the configuration tools user interface unit 210 requests that the configuration server 216 create copies of configuration items stored in the convergent billing database 220. In one embodiment, the request is transmitted to the business process session modules 302 of the configuration server 216. Operations for carrying out the request are described in greater detail below, in the discussion of FIG. 6. From block 510, the flow continues at block 512.

At block 512, it is determined whether the request was successfully performed. For example, the configuration tools user interface unit 210 determines whether the configuration server 216 successfully performed the request. In one embodiment, the configuration server sends an acknowledgement to the configuration tools user interface unit 210 to indicate that the request was successfully performed. If the request were successfully performed, the flow continues at block 514.

At block 514, the presentation of the configuration item icons is modified to reflect the changes. For example, the configuration tools user interface unit 210 modifies the presentation of the configuration item icons to reflect changes to the associated configuration items. As a more specific example, after deleting a configuration item in response to a GUI command, the configuration tools user interface unit 210 deletes the associated configuration item icon from the hierarchy view. From block 514, the flow ends.

As shown in block 516, it is determined whether the command is a command to display differences between configuration items or search for configuration items. For example, the configuration tools user interface unit 210 determines whether the command is a command to display differences between configuration items or search for configuration items. If the command is not a command to display differences between configuration items or search for configuration items, the flow ends. Otherwise, the flow continues at block 518.

At block 518, the command is performed for the configuration items. For example, the configuration tools user interface unit 210 performs the search or differences command. In one embodiment, the search and differences modules 324 performs operations for executing the command. In one embodiment, for a difference command, the search and differences modules 224 determines the differences between two configuration items and returns the results. For example, in one embodiment, the search and differences modules 324 inspects high-level representations of the configuration items for differences. That is, the search and differences module 328 compares attributes between high-level representations of configuration items (e.g., configuration item representations stored in the configuration server database 224).

In one embodiment, for a search command, the search and differences modules 324 searche low-level representations of configuration items for a particular configuration item. Alternatively, in another embodiment, the search and differences modules 324 searche high-level representations of configuration items for a particular configuration item. The flow continues at block 520.

As shown in block 520, the results of the command operations are received. For example, the configuration tools user interface unit 210 receives the results of the search or difference command from the search and differences modules 324. The flow continues at block 522.

At block 522, the results are presented. For example, the configuration tools user interface unit 210 presents the results of the search or difference command. In one embodiment, the configuration tools user interface unit 210 presents the results of a search command as a list of repositories in which the configuration item is stored. In one embodiment, if the search is for a configuration item attribute, the configuration tools user interface unit 210 presents the configuration items and their associated attributes. In one embodiment, the lists are presented in a hierarchy view. In alternative embodiments, the lists are presented in any suitable fashion.

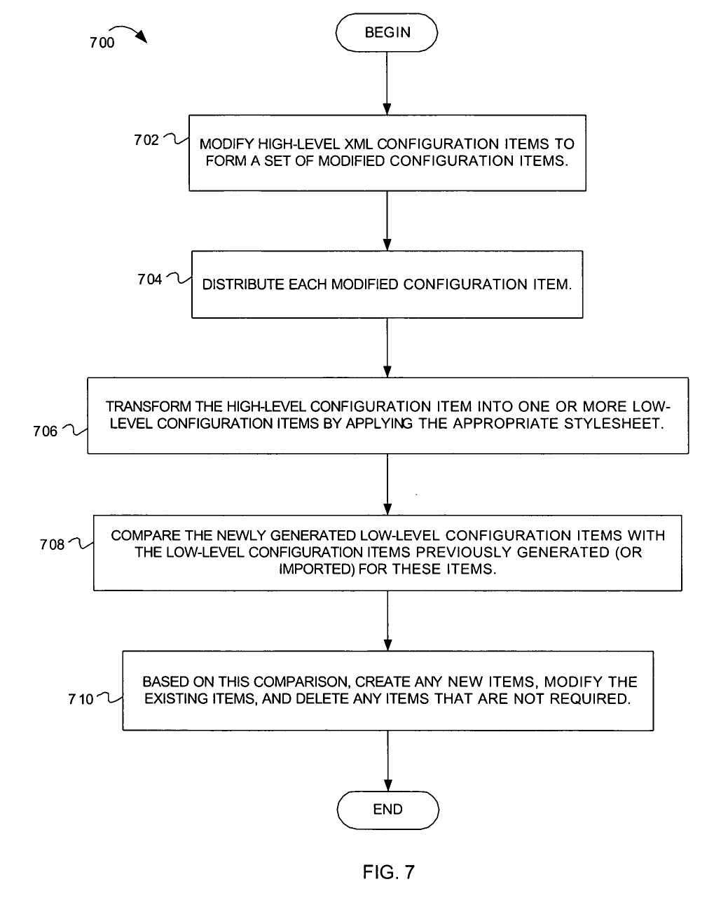

While the discussion of FIG. 5 described operations for receiving GUI commands and presenting configuration items in a GUI, FIGS. 6 and 7 describe operations for modifying and creating configuration as specified by the GUI commands. In performing the operations for carrying-out the GUI commands, the configuration server 216 interacts with other various components of the configuration management system 200. That is, when performing operations for executing GUI commands, the configuration server module 216 requests and receives information from other configuration management system components.

FIG. 6 is a flow diagram illustrating a operations for modifying configuration in response to commands received through a graphical user interface, according to exemplary embodiments of the invention. The flow diagram 600 will be described with reference to the exemplary embodiments shown in FIG. 3. The flow diagram 600 commences at block 602.

At block 602, a request to change low-level configuration items is received. For example, the business process session modules 302 receive a request to change low-level configuration items. In one embodiment, the business process session modules 302 coordinate the completion of the request. The flow continues at block 604.

As shown in block 604, changes to the low-level configuration items are validated. For example, the configuration publisher modules 306 validate changes to the low-level configuration items. In one embodiment, the configuration publisher modules 306 determine whether the requested changes are acceptable. That is, the configuration publisher modules 306 determine whether the requested changes are defined for the selective configuration items. The flow continues at block 606.

At block 606, high-level configuration items are modified to reflect the change request. For example, the entity modules 304 modify the high-level configuration items to reflect the change request. In one embodiment, the entity modules 304 modify, create, and/or delete high-level configuration items to reflect the change request. The flow continues at block 608.

At block 608, a record of the changes, including a start time and a user supplied description, is created. For example, the entity modules 304 creates a record of the changes, where the record includes a start time and the user supplied description. In one embodiment, the start time is taken relative to a system clock. In one embodiment, the user supplied description is received through the graphical user interface and saved to explain reasons why a user has created, modified, or deleted configuration items. The flow continues at block 610.

A block 610, changes to the high-level and low-level configuration items are validated to ensure that constraints are met. For example, the validation modules 308 validate changes to the high-level and low-level configuration items to ensure that constraints are met. In one embodiment, configuration item changes are validated using three types of validation: 1) XML validation—XML validation validates the syntax of XML code; 2) Structure of validation—structure of validation determines whether the XML code structure complies with the structure of the XML schema; and 3) Reference validation—reference validation determines whether references made to other configuration items are valid. The flow continues at block 612.

As shown in block 612, it is determined whether the validations were successful. If the validations were successful, the flow continues at block 614. Otherwise, the flow ends.

At block 614, the changes are committed. For example, and one embodiment, the entity modules 304 commit the changes to the appropriate database. The flow continues at block 616.

At block 616, low-level configuration items are generated from the high-level configuration items. For example, the generation modules generate low-level configuration items based on updated (e.g., created, modified, etc.) high-level configuration items. Operations for generating low-level configuration items are described in greater detail below, in the discussion of FIG. 7. The flow continues at block 618.

As shown in block 618, the low-level configuration items that were generated from the high-level configuration items are validated. For example, the configuration publisher modules 306 validate the low-level configuration items that were generated from the high-level configuration items. In one embodiment, the configuration publisher modules 306 provide different validations then those provided by the validation modules 308, as the configuration publisher modules 308 can examine existing configuration items of a database (e.g., customer management database 226, convergent billing database 220, etc.) to determine whether changes are acceptable. The flow continues at block 622.

At block 622, the low-level configuration items are validated. For example, the validation modules 308 validate the low-level configuration items. The flow continues at block 624.

At block 624, it is determined whether the validations were successful. For example, the business process session modules 302 determine whether the validation was successful. If the validation were successful, the flow continues at block 628. Otherwise, the flow ends.

As shown in block 628, the configuration item changes are exported. For example, the configuration publisher modules 306 export the configuration item changes to the appropriate databases (e.g., OSS 318, customer management database 226, etc.). The flow continues at block 630.

At block 630, status information, including the OSS identifier for each modified configuration item, is provided. For example, the configuration publisher modules provide status information, which includes an OSS identifier for each configuration item updated in the OSS. In one embodiment, this information is written to the database along with the changes to the configuration items. From block 630, the flow ends.

The discussion of FIG. 6 above described modifying configuration items in response to commands received through a graphical user interface. FIG. 7 describes in greater detail the operations for generating low-level configuration items from high-level configuration items (see block 616 of FIG. 6). In the course of modifying configuration items in response to GUI commands, changes are made to high-level configuration items. These changes include operations such as additions, updates, and deletions. The changes must be reflected in the corresponding low-level configuration XML, which in turn can then be exported directly to the OSS 318, customer management database 226, and/or convergent billing database 220.

FIG. 7 is a flow diagram illustrating operations for generating low-level configuration items from high-level configuration items, according to exemplary embodiments of the invention. The flow diagram 700 will be described with reference to the exemplary configuration management system shown in FIG. 3. The flow commences at block 702.

At block 702, high-level XML configuration items are modified to form a set of modified configuration items. For example, the configuration generators 312 modify high-level XML configuration items to form a set of modified configuration items. For example, the configuration generators 312 modify the high-level configuration items when creating, modifying, or deleting configuration items stored in an OSS. The flow continues at block 704.

As shown block 704, each modified configuration item is distributed. For example, the configuration generators 312 distributed the configuration items to the customer management configuration generator 314 and the convergent billing configuration generator 316. In one embodiment, each configuration generator will process only those modified configuration items that it is designed to handle. For example, the customer management configuration generator 314 processes customer management related configuration items, while ignoring convergent billing configuration items. The flow continues at block 706.

At block 706, the high-level modified configuration items are transformed into one or more low-level configuration items by applying stylesheets. For example, the customer management configuration generator 314 and the convergent billing configuration generator 316 apply stylesheets to the high-level modified configuration items to transform them into one or more low-level configuration items. In one embodiment, each generator has a stylesheet associated with it. In one embodiment, the stylesheets are stored in the configuration server repository. In one embodiment, as each modified configuration item is received by the appropriate configuration generator, a generation process is invoked. This process applies the stylesheet to the high-level configuration item, transforming it into one or more low-level configuration items. In one embodiment, the stylesheets conform to the XSL stylesheet language of XML. The XSL stylesheet allows for transformation of XML documents into other formats, such as HTML, or into other XML documents. XSL consists of three parts: 1) XSL—a language for transforming XML documents; 2) XPath—a language for addressing elements of XML document; 3) XSL Formatting Objects—a vocabulary for formatting XML documents.

In one embodiment, the output of the generation process is one or more low-level XML documents, each containing a low-level configuration item. In one embodiment, while some high-level configuration item elements, such as name and description, can be directly copied from a low-level XML document, most elements need more processing before they can be represented as low-level configuration items. In one embodiment, the additional processing includes adding information to the low-level configuration elements. The flow continues at block 708.

At block 708, the newly generated low-level configuration items are compared with the low-level configuration items previously produced for those items. For example, the configuration generators 312 compares the newly generated low-level configuration items with low-level configuration items previously produced for those configuration items. In one embodiment, this comparison is used in determining whether configuration items should be created, modified, or deleted. For example, if revision 1 of configuration item A generates configuration items X, Y, and Z. A is then updated and revision 2 generates configuration items Q, Y′, and Z. As a result, Q is created, X is deleted, Y is modified to be Y′, and Z is left unmodified. The flow continues at block 710.

As shown in block 710, based on the comparison, configuration items are created, modified, or deleted as needed. For example, and one embodiment, the configuration generators 312 creates new items, modifies existing items, and/or deletes items that are not needed, based on the comparison (performed at block 708). From block 710, the flow ends.

Thus, a system and method for hierarchically representing configuration items have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
graphically presenting a set of one or more icons, wherein the icons are associated with a configuration management system repository and configuration items stored in the configuration management system repository, wherein the icons are presented in a hierarchical view;
receiving a command associated with the set, wherein the command is received through a graphical user interface, and wherein the command is associated with operations for modifying the configuration management system repository;
requesting performance of the operations for modifying the configuration management system repository; and
modifying the graphical presentation of the set to reflect the modification of the configuration management system repository.

2. The method of claim 1, wherein the configuration management system repository includes an operation support system.

3. The method of claim 1, wherein the operations for modifying the configuration management repository are selected from the set consisting of a copy operation, a delete operation, a move operation, a search operation, and a difference operation.

4. The method of claim 1, wherein the configuration management system repository is represented at a highest level of the hierarchy.

5. A method comprising:
receiving a request to modify one or more configuration items, wherein the request is associated with a direct manipulation GUI command, wherein the configuration items are associated with configuration item icons, and wherein the configuration items are stored in a configuration management system repository;
modifying the one or more configuration items, wherein the modifying includes modifying high-level representations of the one or more configuration items;
generating low-level representations of the one or more configuration items; and
exporting the low-level representations to a database.

6. The method of claim 5, wherein the high-level representations include Extensible Markup Language (XML) code.

7. The method of claim 5, wherein the low-level representations are generated based on the high-level representations.

8. The method of claim 7, wherein the low-level representations include XML code.

9. The method of claim 5, wherein the database is part of an operations support system.

10. The method of claim 5, wherein the configuration management system repository is part of an operations support system.

11. A method comprising:
receiving a request to change contents of a configuration management system repository, wherein the contents include a first set of low-level configuration items, wherein the request is based on a copy command, a delete command, or a move command received from a graphical user interface (GUI), and wherein the GUI presents the configuration items in a hierarchy view;
changing the contents of the configuration management system repository based on the request, wherein the changing includes,
creating, modifying, or deleting high-level configuration items, wherein the high-level configuration items are associated with ones of the first set of low-level configuration items;
transforming the high-level configuration items into a second set of low-level configuration items, wherein the transforming includes applying one or more of a third set of stylesheets;
comparing the second set to the first set; and
creating, modifying, or deleting ones of the first set, based on the comparing.

12. The method of claim 11, wherein the high-level configuration items are represented using Extensible Markup Language (XML).

13. The method of claim 11, wherein the low-level configuration items are represented using XML.

14. The method of claim 11, wherein the configuration management system repository is part of an operations system support system.

15. An apparatus comprising:
a configuration tools user interface unit adapted to perform the following:
graphically present a set of one or more icons, wherein the icons are associated with a configuration management system repository and configuration items stored in the configuration management system repository, wherein the icons are presented in a hierarchical view;
receive a command associated with the set, wherein the command is received through a graphical user interface, and wherein the command is associated with operations for modifying the configuration management system repository;
request performance of the operations for modifying the configuration management system repository; and
modify the graphical presentation of the set to reflect the modifications to the configuration management system repository.

16. The apparatus of claim 15, wherein the configuration management system repository includes an operation support system.

17. The apparatus of claim 15, wherein the operations for modifying the configuration management repository are selected from the set consisting of a copy operation, a delete operation, a move operation, a search operation, and a difference operation.

18. The apparatus of claim 15, wherein the configuration management system repository is represented at a highest level of the hierarchy.

19. A machine-readable medium that provides instructions, which when executed by a machine, cause the machine to perform operations comprising:
graphically presenting a set of one or more icons, wherein the icons are associated with a configuration management system repository and configuration items stored in the configuration management system repository, wherein the icons are presented in a hierarchical view;
receiving a command associated with the set, wherein the command is received through a graphical user interface, and wherein the command is associated with operations for modifying the configuration management system repository;
requesting performance of the operations for modifying the configuration management system repository; and
modifying the graphical presentation of the set to reflect the modification of the configuration management system repository.

20. The machine-readable medium of claim 19, wherein the configuration management system repository includes an operation support system.

21. The machine-readable medium of claim 19, wherein the operations for modifying the configuration management repository is selected from the set consisting of a copy operation, a delete operation, a move operation, a search operation, and a difference operation.

22. The machine-readable medium of claim 19, wherein the configuration management system repository is represented at a highest level of the hierarchy.

23. A machine-readable medium that provides instructions, which when executed by a machine, cause the machine to perform operations comprising:
receiving a request to modify one or more configuration items, wherein the request is associated with a direct manipulation GUI command, wherein the configuration items are associated with configuration item icons, and wherein the configuration items are stored in a configuration management system repository;
modifying the one or more configuration items, wherein the modifying includes modifying high-level representations of the one or more configuration items;
generating low-level representations of the one or more configuration items; and
exporting the low-level representations to a database.

24. The machine-readable medium of claim 23, wherein the high-level representations include Extensible Markup Language (XML) code.

25. The method of claim 23, wherein the low-level representations are generated based on the high-level representations.

26. The machine-readable medium of claim 23, wherein the low-level representations include XML code.

27. The machine-readable medium of claim 23, wherein the database is part of an operations support system.

28. The machine-readable medium of claim 23, wherein the configuration management system repository is part of an operations support system.

29. A machine-readable medium that provides instructions, which when executed by a machine, cause the machine to perform operations comprising:
receiving a request to change contents of a configuration management system repository, wherein the contents include a first set of low-level configuration items, wherein the request is based on a copy command, a delete command, or a move command received from a graphical user interface (GUI), and wherein the GUI presents the configuration items in a hierarchy view;
changing the contents of the configuration management system repository based on the request, wherein the changing includes,
creating, modifying, or deleting high-level configuration items, wherein the high-level configuration items are associated with ones of the first set of low-level configuration items;
transforming the high-level configuration items into a second set of low-level configuration items, wherein the transforming includes applying one or more of a third set of stylesheets;
comparing the second set to the first set; and
creating, modifying, or deleting ones of the first set, based on the comparing.

30. The machine-readable medium of claim 29, wherein the high-level configuration items are represented using Extensible Markup Language (XML).

31. The machine-readable medium of claim 29, wherein the low-level configuration items are represented using XML.

32. The machine-readable medium of claim 29, wherein the configuration management system repository is part of an operations system support system.
